(19) United States
(12) Patent Application Publication
(10) Pub. No.: US 2003/0230734 A1
(43) Pub. Date: Dec. 18, 2003

(54) Apparatus and method for detecting the orientation of textile products such as stockings and socks

(76) Inventor: Gino Bassi, Bologna (IT)

Correspondence Address: MCGLEW & TUTTLE, PC, SCARBOROUGH STATION, SCARBOROUGH, NY, 10510, US

(21) Appl. No.: 10/452,649

(22) Filed: Jun. 2, 2003

(30) Foreign Application Priority Data
Jun. 18, 2002 (IT) FI2002A000106

(51) Int. Cl. G01V 8/00

(52) U.S. Cl. 250/559.4

(57) ABSTRACT

Apparatus for detecting the orientation of textile products such as stockings and socks having closed or open toe, to be used in a plant for the automatic treatment of said articles in which they are pneumatically moved, upstream of a machine or equipment (6) to which said articles must come in a predetermined orientation, that is, presented with either their toe or opposite portion thereof facing the section for the introduction of the articles into the machine (6), and downstream of removal means (2) able to pick up one or more articles from the container (1) in which the article are disposed in bulk, apparatus characterized in that it comprises:

a tubular chamber (30) with articles' input/output section (300);

a fixed pin (31), onto which said articles are fitted, which is disposed centrally within said chamber (30), substantially coaxial thereto;

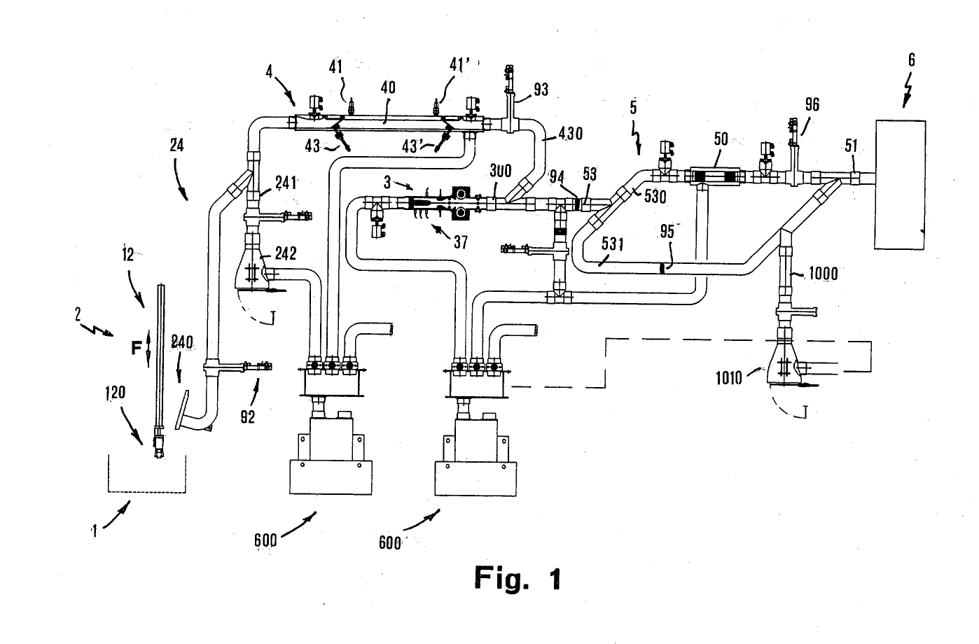

means (37) for detecting the presence of an article fitted onto said pin (31). (FIG. 1).

The present invention refers to an apparatus and a method for detecting articles such as stocking or stocks.

The present invention makes it possible to fully automate the process of loading articles such as stockings and socks with their toe being either closed or open onto the shapes of an ironing machine, or other machine or equipment, to be supplied with the said articles oriented in a predetermined way.

This result has been achieved, according to the invention, by adopting the idea of making an apparatus having features as indicated in the characterizing part of independent claims. Further characteristics being set forth in the dependent claims.

The present invention makes it possible to automatically operate the removal of stockings and stocks having closed or open toe from a container wherein they are disposed in bulk, the orientation thereof in a predetermined way, and subsequent loading onto shapes of a ironing machine or other machines and equipment. Moreover, an apparatus according to the invention is relatively simple to make, cost-effective and reliable even after a prolonged service life.

These and other advantages and characteristics of the invention will be best understood by a reading of the following description in conjunction with the attached drawings given as a practical exemplification of the invention, but not to be considered in a limitative sense, wherein:

FIG. 1 is a simplified diagram of a plant comprising an apparatus according to the invention;

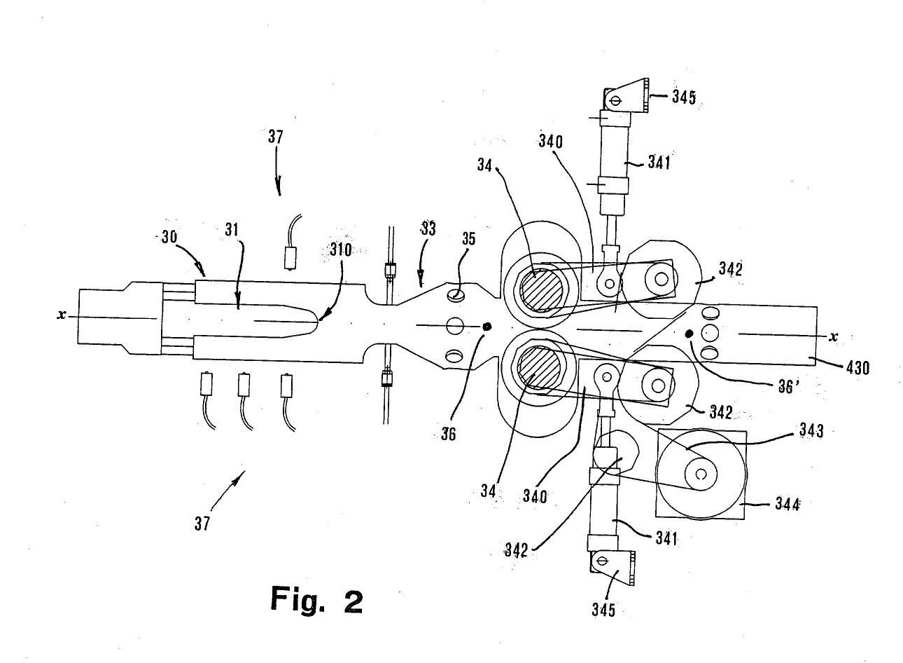

FIG. 2 is a schematic longitudinal view of an apparatus according to the invention;

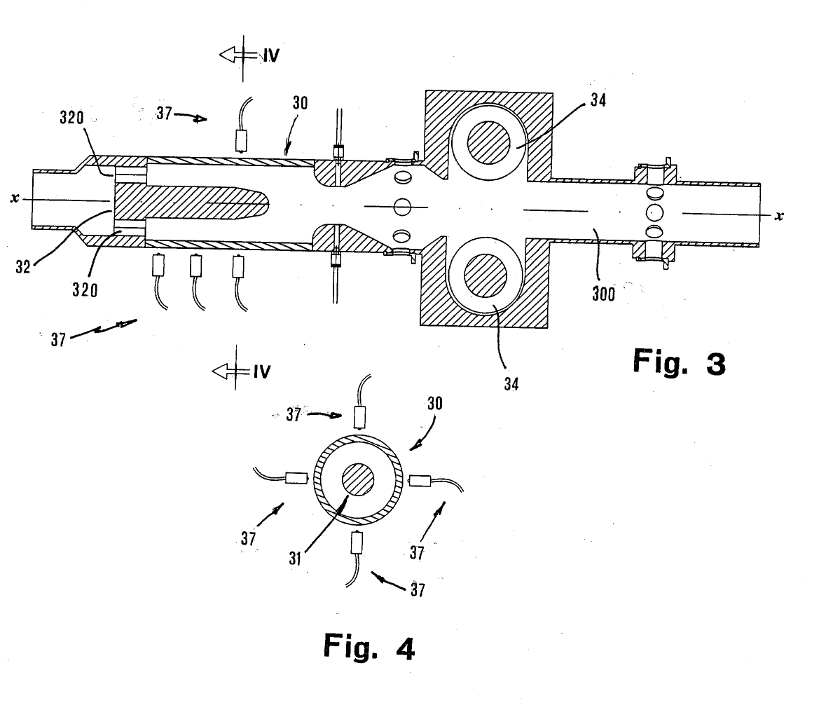

FIG. 3 is a view in longitudinal section of the apparatus of FIG. 2, with some parts omitted for a clearer representation of others;

FIG. 4 is a cross-section view of the exemplary embodiment of the apparatus shown in FIG. 3, taken on line IV-IV;

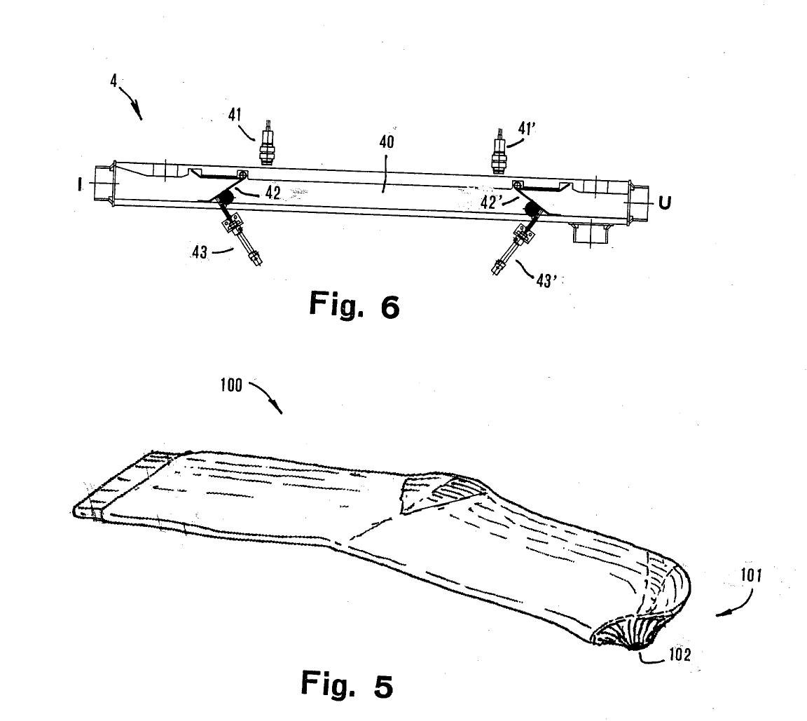

FIG. 5 shows schematically a sock with the toe still to be sewn;

FIG. 6 shows an enlarged detail of FIG. 1.

According to the example shown in FIG. 1, an apparatus in compliance with the invention can be used in a plant for the automatic treatment of artcicles such as stocking, socks and the like, that is, the removal thereof from a container (1) wherein the articles are disposed in bulk, the detection of their orientation after said removal from the container (1), the reversal, as necessary, of said orientation, and finally the discharge thereof in a condition of predetermined orientation. Downstream of the outlet for the discharge of the articles, provision may be made for a machine of a kind to be supplied with the articles oriented in a predetermined way.

The plant in question comprises means (2) for removing the articles from the container (1) and transferring them thus removed from the container (1) to the detection device (3) in correspondence of which the orientation thereof is revealed (as best described later on). Between said means (2) for the removal of a articles from the container (1) and the detection apparatus (3), so called “single-handling” means (4) are provided from which one article at a time would come out even if the means (2) should remove more than one article. Downstream of the detection apparatus (3) means are provided for reversing the orientation of the articles should such orientation be different from the wanted one. When exiting from means (5) each article results oriented as desired, that is, in a predetermined way. Indicated with numeral (600) in FIG. 1 are two aspirators able to create pmeumatic flows having the function to be described later.

For example, the said means (2) for removing the articles from the container (1) may be of a type disclosed in the Patent No. (IT) PI/2001/A/22, that is, of a type comprising a gripper (120) mounted on the lower end of a support having vertical axis (12) and movable from and to the container (1) as indicated by the double arrow “F”. The gripper (120) is of a type with normally open jaws which are closed under control of sensor means (solid to the gripper's body) when the gripper (120) results in proximity of the heap formed by the articles present in the container (1). To operate the removal of one article from the container (1), the support (12) is moved down so as to bring the gripper (120) close to the heap of articles. When the sensor means detect the closeness of gripper (120) to the heap of articles, they operate the closing of the relevant jaws which, in this way, seize one or more articles of the heap. In the subsequent step for lifting the support (12), the articles hanging from the gripper (120) are moved to the inlet section or mouth (240) of a pipe (24) which leads into the single-handling device (4). By deactivating the gripper (120), so as to open its jaws and thus releasing the articles previously seized, and activating a suction within the pipe (24) (for example, by means of a valve (91) provided on said pipe), there is obtained the transfer of the articles from the gripper (120) to the single-handling device (4). The latter, for example, may be of a type including a tubular chamber (40) wherein optical photocell means (41, 41′) are disposed to act respectively downstream or upstream of relevant movable gates (42, 42′) for detecting the presence of articles in correspondence thereof. The gates (42, 42′) are associated with corresponding actuators (not shown in the drawings) and are positioned within the chamber (40) to obstruct (when lowered) and to release (when lifted) the inlet (I) and outlet (U) sections, respectively. In correspondence of the lower edge of each gate (42, 42′) the rod of a corresponding stationary cylinder (43, 43′) is made to act, the rod of each cylinder (43, 43′) being positioned for going through a corresponding hole formed in the outside wall of chamber (40). When the means (2) hand the articles over to the tube (24) as previously described, tha gate (42) is lifted and gate (42′) lowered, the rods of cylinders (43, 43′) being both retracted. The disposition of the articles within the chamber (40) having thus taken place, the rod of the cylinder (43′) is withdrawn to such an extent as to bring the respective free end in correspondence of the gate (42′), thereby blocking the article's fabric between the tip of the rod and the gate's wall. During this step, the suction within the chamber (40) is maintained in the direction of outlet (U). Subsequently, the suction is reversed so that, if more articles are introduced into the chamber (40), all of them which are not blocked, as previously described, transit again through the section (I) of chamber (40) and are brought back into the container (1) via a discharge branch (241) of conduit (24) (which branch will be opened beforehand in correspondence of a gate 92), at the end of which there is located a discharge manifold or “pot” (242) known per se. Upon completion of the discharge of extra articles, that is, articles not blocked by the rod of cylinder (43′) and gate (42′), the gate (42) is lowered and the rod of cylinder (43′) is withdrawn so that the article previously blocked by the latter is released and moves up to the gate (42). At this point, the rod of cylinder (43) is drawn out for blocking the article at the gate (42), the gate (42′) is lifted and the suction is started in direction of outlet (U), after which, the thus stretched article is released by retracting the rod of cylinder (43).

The “single-handling” procedure above described, and known per se to those skilled in the art, allows only one article, in stretched condition, to come out from the chamber (40), even if the means (2) should remove more than one article from the container (1).

The outlet section (U) of chamber (40) is connected with the device (3) for detecting the articles' orientation through a conduit (430) on which a gate (93) is disposed.

The device (3) comprises a tubular chamber (30) with only one section (300) for articles' inlet/outlet, and receives a fixed central pin (31) disposed along the respective longitudinal axis (x-x). The said pin (31) has a shape substantially cylindrical with a rounded tip (310) and is fixed to a support base (32) provided with longitudinal through holes (320). Provided between the pin (31) and the articles' inlet/outlet section is a convergent-divergent conduit (33). Provided in correspondence of said articles' inlet/outlet section is a pair of motor-driven rollers (34) arranged in facing relationship. The rollers (34) are carried by the end of respective arms (340) onto which relevant actuators (341) are made to act and which, being engaged with fixed parts (345) of the machine, make it possible to change the distance between two rollers (34). The rollers (34) are kinematically connected to a motor member (344) via a belt (343) and a plurality of transmission pulleys (342) which are so disposed as to allow the transmission of the motion from the motor (344) to the rollers (34) also during the displacement of the rollers when they move close to or away from each other under control of the actuators (341) acting directly on arms (340).

Moreover, the chamber (30) has a plurality of radial through holes (35) in correspondence of a section located between the rollers (34) and the conduit (33). Disposed upstream and respectively downstream of rollers (34) (that is, to the right and to the left, in the drawing of FIG. 2) are two photocells or groups of photocells (36′, 36) whose optical axes are pointed towards the longitudinal axis (x-x) of the chamber (30).

An article on input to the device (3) is detected by the photocells (36′) which start the cylinders (341), the latter bringing the rollers (34) close to each other. Advantageously, the rollers (34) are slotted so as not to block the air flow also in case their respective cylindrical surfaces are in contact to each other. Concurrently, the motor (344) is started to drive rollers (34) into rotation. The article is therefore compressed between the rollers (34), which cause it to transit downstream, that is, towards the convergent-divergent conduit (33). If the article (stocking or sock with closed toe) comes up by being oriented with the portion of the hem or elastic edge downstream, that is, with the unsewn portion turmed forwards with respect to the direction of the introduction thereof into the chamber (30), the transit of the article through the conduit (33) is cause for it to be disposed in open configuration, that is, the mouth defined by the open portion of the hem or elastic edge opens up and fits onto the pin (31). Provided on the rollers (34), that is, connected therewith, is a measuring device able to evaluate the length of the portion of article passing through the rollers (34); in practice, provision may be made for a device which determines, based on the number of revolutions or steps made by the rollers and the diameter thereof, the extent of the article passing through the rollers (34). The reading of the meter may, advantageously, be related to the detections of the photocells (36, 36′).

If the article on input to the device (3) comes up with its toe facing the pin (31) and, during its advancement, turns itself inside out, then the data evaluated by counting the steps made by the rollers (34) is greater than the one corresponding to the case when the article, by presenting itself with the hem facing the pin (31), fits onto the latter. The count value corresponding to the latter case is a known and preset value (n_{ref}) with which the value (n) detected each time through the count of the steps made by the rollers (34) is compared: if n_{ref}>n, then there is assumed that the article results with the toe facing the pin (31), that is, turned inside out or not fitted onto the same. In this circumstance, by reversing the motion of rollers (34) it is possible either to bring the article back in correspondence of the inlet section of the device (3), in order to repeat the same operation at least once, or to assume that the article is oriented with the toe facing the pin (34).

Moreover, provision is made for a plurality of photocells (37) disposed in correspondence of chamber (30) and oriented towards the pin (31). The photocells (37) are able to intercept (all together) the article when this is fitted onto the pin (31), that is, when the article is oriented with the portion of elastic hem facing the base (32) of pin (31).

In case the article comes up with the elastic portion forwards, this will be obviously the first to transit through the conduit (33) and arrive at the chamber (30). Having the conduit (33) operated the opening or stretching apart of the article, the said elastic portion thereof will begin to be fitted onto the pin (31) and, for this reason, the same article will continue its travel downstream, that is, towards the base (32) of the pin (31) and result intercepted by the photocells (37).

On the contrary, in case of an article coming up with its toe forwards, the latter will not be able to be fitted onto the pin (31) and, for this reason, will result disposed, in its travel towards the pin (31), fully sideway of the pin (31). The relevant interception of the article by one photocell (37) or only by some photocells (37) but not by all of them—a detection to be combined with the result of the count of steps of rollers as previously described—corresponds to the identification of the orientation of an article with its toe forwards. The article oriented with the toe forwards might also remain resting on the distal end (310) of the pin (31) and, in this case, the signal revealing the article with its toe forwards would be given by a lack of interception by all the photocells (37).

Once the article's orientation has been identified, the same article is released. For this operation, the rollers (34) are moved away from each other and a suction is started which determines the exit of the article, the relative orientation of which being thus known.

Mounted downstream of the device (3) is a pneumatic circuit (5) for the possible reversal of articles' orientation. According to the example of FIG. 1, the said circuit (5) comprises a conduit (53) connected with the input/output section of the device (3) and subdivided downstream into an upper branch (530) and a lower branch (531). Provided on the conduit (53) is a relevant gate (94). Mounted in series on the upper branch (530) is an anti-twist device (50) known per se. Downstream of the anti-twist device (50) is the discharge (51) of the articles, which are taken to a final working station (6) wherein an ironing machine or the like, is made to operate.

The outlet of the lower branch, which bypasses the device (50), is in correspondence of said discharge (51).

If the articles arrive at the downstream machine (6) all having their elastic or hem forwards, those on output from the device (3) so oriented are caused to transit through the upper branch (530) as far as the machine (6). On the contrary, those articles having their toe forwards, are made to reverse their orientation within the circuit (5). In this case, the articles will transit along the upper branch (530) as far as the gate (96) provided on the upper branch (530) downstream of the anti-twist device (50) and disposed, in this case, in closing configuration. At this point, the gate (94) of conduit (53) will be closed and, by a suction, the article will be made to transit—this time in a direction opposite to the previous one—through the same portion of upper branch (530) and arrive at the lower branch (531). In the lower branch (531) there is provided a further gate (95), which will be open to allow the passage of the article as far as the outlet section (51), which coincides with the inlet section of the machine (6). Described hereunder is a possible example of operation of the device, according to the invention, in conjunction with the plant where it can be disposed.

At least one article (not shown in the drawings) is removed out of container (1) by means of the gripper (120). One or more articles are then lifted and, in correspondence of section (240) are subjected to a suction which makes them to enter the tube (24) and, through the latter, takes them up to the single-handling device (4). On output from the single-handling device (4) only one article will be present within the conduit (430), which article will arrive at the device (3) detecting the orientation thereof in a manner similar to that previously described. In practice, the article arriving through the conduit (430) is intercepted by the photocell (36′), thereby determining the double activation of rollers (34), that is, for moving them close to each other (for the operation of actuators (341)) as well as driving them into rotation (for the operation of motor (344)).

The article in transit through the rollers (34) is taken to the chamber (30) where, if it is oriented with the elastic portion forwards, is able to fit onto the pin (31)—this condition being revealed by all the photocells (37); otherwise, it is assumed that the article is oriented with its toe forwards, that is, facing the pin (31). On output from the device (3), therefore, the system is able to know the orientation of the articles as they are gradually removed and, as a function of the actual orientation, to carry out or not the reversal of orientation of the articles within the circuit (5), prior to feed them to the machine (6) located downstream.

The said machine (6) may be, for example, an ironing machine, provided with means for the automatic loading of stockings oriented in a predetermined way, of a type described in the document (IT) PI/2000/A/27.

The above described apparatus can be used also for the treatment of articles like stocking and socks (100) having their toe (101) still to be sewn and, more particularly, stockings and socks whose toe (101) has an aperture (102) smaller than the diameter of the pin (31). When the article (100) comes to the pin (31) with its toe forwards, there is occurs what has been previously described in relation to the case with closed toe since the article can not fit onto the pin—the diameter of the latter being incompatible with the said aperture (102). For example, the article (100) may be knitted with a circular machine of traditional type by forming the last ranks of stitches with the use of an elastic thread which gives rise to a restricted form as shown in the figure, which form is to be cut and disposed of when sewing the article's toe. The said sewing and cutting steps are known to those skilled in the art and, therefore, will not be described in greater detail.

Possibly provided as a by-pass of branch (531) of circuit (5) is an outlet pipe (1000) with relevant end pot (1010) for the discharge of articles in case of an emergency such as for clearing the whole plant by removing, when necessary, all the articles present therein.

Practically, the construction details may vary in any equivalent way as far as the shape, dimensions, elements disposition, nature of the used materials are concerned, without nevertheless departing from the scope of the adopted solution idea and, thereby, remaining within the limits of the protection granted to the present patent for industrial invention.

1. Apparatus for detecting the orientation of textile articles such as stockings and socks having closed or open toe, to be used in a plant for the automatic treatment of said articles in which they are pneumatically moved, upstream of a machine or equipment (6) to which said articles must come in a predetermined orientation, that is, presented with either their toe or opposite portion thereof facing the section for the introduction of the articles into the machine (6), and downstream of removal means (2) able to pick up one or more articles from the container (1) in which the article are disposed in bulk, apparatus characterized in that it comprises:
a tubular chamber (30) with articles' input/output section (300);
a fixed pin (31), onto which said articles may fit, which is disposed centrally within said chamber (30), substantially coaxial thereto;
means (37) for detecting the presence of an article fitted onto said pin (31).

2. Apparatus according to claim 1, characterized in that it comprises a convergent-divergent conduit (33) disposed between said pin (31) and said input/output section (300).

3. Apparatus according to claim 1, characterized in that it is provided with two photocells or groups of photocells (36′, 36) whose optical axes are oriented (pointed) towards the longitudinal axis (x-x) of the chamber (30).

4. Apparatus according to claim 1, characterized in that it comprises a measuring device connected to rollers (34) located at the intlet of said chamber (30) and able to evaluate the length of the portion of each article passing through said inlet section of chamber (30).

5. Apparatus according to claim 4, characterized in that said measuring device comprises means for measure the number of revolutions made by the rollers (34).

6. Apparatus according to claim 4, characterized in that said rollers (34) are disposed facing each other in correspondence of said input/output section (300) and supported by respective arms (340) able to change bidirectionally the distance between the two rollers (34) by passing from a stand-by configuration, in which thet are spaced apart, to a driving configuration, in which the rollers are in contact to each other to cause an article to transit through said input/output section (300).

7. Apparatus according to claim 1, characterized in that said rollers (34) are slotted.

8. Apparatus according to claim 1, characterized in that said means (37) for detecting the presence of an article fitted onto said pin (31) are made up of a plurality of photocells (37) disposed in correspondence of the chamber (30) and oriented towards the pin (31).

9. Apparatus according to claim 1, characterized in that it is disposed upstream of means able to reverse the orientation of the articles.

10. Method for detecting the orientation of textile articles such as stockings and socks having closed or open toe, characterized in that it comprises moving each article towards a pin (31) and detecting whether the articles moved towards the said pin fit or not onto the same pin.

11. Method according to claim 10, characterized in that the said detection is carried out by optical means (37) oriented towards the said pin (31).

12. Method according to claims 10 and 11, characterized in that the said detection takes place within a tubular chamber (30) which receives the said pin (31).

13. Method according to claim 10, characterized in that it comprises to reverse, as necessary, the orientation of the articles subsequently to said detection.
